(19) United States
(12) Patent Application Publication
(10) Pub. No.: US 2020/0112281 A1
(43) Pub. Date: Apr. 9, 2020

(54) Drive Train and Method for Operating a Drive Train

(71) Applicant: Bayerische Motoren Werke Aktiengesellschaft, Muenchen (DE)

(72) Inventor: Dieter ZIEGLTRUM, Vaterstetten (DE)

(21) Appl. No.: 16/708,181

(22) Filed: Dec. 9, 2019

Related U.S. Application Data
(63) Continuation of application No. PCT/EP2018/064827, filed on Jun. 6, 2018.

(30) Foreign Application Priority Data
Jun. 27, 2017 (DE) 10 2017 210 739.1

(51) Int. Cl. H02P 27/06; H02K 7/00; H02K 5/22

(52) U.S. Cl. CPC H02P 27/06; H02K 5/225; H02K 7/006

(57) ABSTRACT

A drive train, which is configured to electrically operate a vehicle, includes an electric motor and a first and second energy store, each of which is electrically connected to the electric motor. The drive train also includes a first inverter and a second inverter, where the first inverter is provided between the first energy store and the electric motor, and where the second inverter is provided between the second energy store and the electric motor. The electric motor has four phases.

### CROSS REFERENCE TO RELATED APPLICATIONS

This application is a continuation of PCT International Application No. PCT/EP2018/064827, filed Jun. 6, 2018, which claims priority under 35 U.S.C. § 119 from German Patent Application No. 10 2017 210 739.1, filed Jun. 27, 2017, the entire disclosures of which are herein expressly incorporated by reference.

### BACKGROUND AND SUMMARY OF THE INVENTION

The invention relates to a drive train for an electrically operated vehicle, and to a method for operating a drive train.

In electrically operated vehicles, i.e. hybrid vehicles, plug-in hybrid vehicles, or vehicles which are driven by electricity only, batteries, accumulators or fuel cells are employed as energy stores or energy sources. Within a predefined voltage range, one of these energy stores consistently delivers a predefined maximum current strength, whereby the power of the electric motor of the electrically operated vehicle is limited accordingly.

As a result, extensive product ranges of mass-produced electrically operated vehicles are not possible, as can be achieved, for example, by different engine variants in vehicles which are equipped with a combustion engine. However, this variety of production is desirable, as vehicles are purchased for various purposes, and also have different power requirements accordingly.

For the resolution of this problem, it is known for energy stores of different capacity, or for two energy stores to be provided, which are connected to one or more power inverters (also described as inverters), such that the phases of the electric motor can be supplied with electric current. In the event of the provision of two energy stores, an energy transformer or DC voltage converter (also described as a DC/DC converter) is required between the two energy stores, in order to permit the transfer of energy from the individual energy stores to the electric motor, or the mutual transfer of energy between the energy stores. However, if the maximum power of the electric motor is required, this DC voltage converter must be capable of transferring the full capacity of the second energy store. Accordingly, the DC voltage converter must have a capacity of equal magnitude to that of the electric motor installation, such that DC voltage converter requires a large installation space, is expensive, and is associated with a substantial increase in weight.

An object of the invention is thus the provision of a cost-effective drive train and a method for operating a drive train having no DC voltage converter or having a DC voltage converter of substantially lower capacity, for an equal maximum capacity of the electric motor.

This object is fulfilled by a drive train for an electrically operated vehicle, having an electric motor, a first energy store and a second energy store, which are each electrically connected to the electric motor, a first inverter and a second inverter, wherein the first inverter is provided between the first energy store and the electric motor, and wherein the second inverter is provided between the second energy store and the electric motor, wherein the electric motor has four phases U₁, V₁, U₂, V₂. The two inverters are mutually isolated, i.e. the conversion of DC into AC proceeds in a mutually isolated manner. To this end, the inverters can comprise separate units, or can equally well be constituted as a common unit, in which DC from each of the energy stores is converted into AC in a mutually separate manner.

In order to permit cost-effective implementation and for the simplification of actuation, the electric motor has four phases. This reduces the complexity of manufacture of the electric motor.

An electrically operated vehicle can be an all-electric vehicle or a (plug-in) hybrid vehicle. Likewise, more than two energy stores and/or one or more electric motors can also be provided.

As a dedicated inverter is provided for each energy store, energy from one of the energy stores can be directly transmitted via the associated inverter to the electric motor, without the necessity for a DC voltage converter for this purpose. Accordingly, the DC voltage converter can be omitted, or the capacity of such a DC voltage converter can at least be substantially reduced.

Preferably, at least one of the phases U₁, V₁ is only connected to the first inverter, and another of the phases U₂, V₂ is only connected to the second inverter. As a result, the at least one phase is exclusively supplied with electric current from the energy store which is assigned thereto, as a result of which each energy store can deliver its energy directly to the electric motor, with no further components (apart from the inverters).

For example, the first inverter and the second inverter are exclusively connected to different phases of the electric motor, thus permitting the simplification of the design of the drive train.

Accordingly, the first inverter and the second inverter are two-phase inverters. This permits the economization of one power output stage with highside and lowside switches in each case. Moreover, actuation and monitoring functions for said power output stage can also be omitted. Moreover, the electrical connection (busbar) between the inverter and the electric motor is reduced by one element. Costs, weight, and the installation space for power electronics are reduced accordingly.

In order to ensure that, upon start-up, the electric motor rotates in the desired direction, in the event of actuation, for example, by means of the first inverter, one phase of the second inverter U₂ or V₂ is employed as an “auxiliary phase”. Accordingly, for the start-up of the electric motor, quasi-three-phase operation is assumed, as per currently employed electric motors. Immediately the electric motor is rotating in the desired direction, the “auxiliary phase” of the second inverter can be switched off, as the motor is now running in the preferred direction. Naturally, actuation can also be executed by means of the second inverter, and the auxiliary phase U₁ or V₁ of the inverter can be employed. If both inverters are employed simultaneously, e.g. in the event of high power demand, the electric motor operates as a four-phase machine.

In one configuration of the invention, the first energy store and the second energy store are electrically interconnected via a DC voltage converter. This connection via the DC voltage converter is thus provided additionally to the connection of the two energy stores via the electric motor. By means of the DC voltage converter, the transfer of energy between the two energy stores can be controlled. Given that, in this case, the DC voltage converter is only required for the exchange of energy between the energy stores and not for the propulsion of the electric motor, it is not necessary for the DC voltage converter to have the capability for the transfer of the full capacity of one of the energy stores. The DC voltage converter can thus be dimensioned to a lower rating.

The energy stores can be batteries, accumulators, capacitors and/or fuel cells, in order to permit the storage or delivery of energy in a simple and reliable manner.

The object is further fulfilled by a method for operating a drive train according to one of the preceding claims, comprising at least one of the following steps:

The infeed of energy to the electric motor from one or both energy stores simultaneously,

The feedback of energy from the electric motor to one or both energy stores simultaneously, or

The infeed of energy to the electric motor from one of the energy stores and the simultaneous feedback of energy from the electric motor to the other energy store. This permits the transfer of energy from one store to the other using the means present, without the additional association of a DC/DC converter.

By the connection of the energy store to a dedicated inverter in each case, the functions of a DC voltage converter according to the prior art can be assumed by the electric motor itself. Specifically, the second inverter, for example during a braking process, can be operated such that it transfers energy from the electric motor to the second energy store, wherein, simultaneously, the first inverter transfers energy from the first energy store to the electric motor. In this manner, an energy transfer from the first energy store to the second energy store is effectively possible. This method for operating the drive train is possible, independently of the number of phases of the electric motor. Even a different number of phases on the first and second inverter is possible.

Further characteristics and advantages of the invention proceed from the following description, and from the attached drawings, to which reference is made. In the drawings:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1: shows a schematic circuit diagram of a first form of embodiment of a drive train according to the invention.

FIG. 2: shows a schematic circuit diagram of a second form of embodiment of a drive train according to the invention.

FIG. 3: shows a schematic circuit diagram of a third form of embodiment of a drive train according to the invention.

FIG. 4: shows a schematic circuit diagram of a fourth form of embodiment of a drive train according to the invention.

### DETAILED DESCRIPTION OF THE DRAWINGS

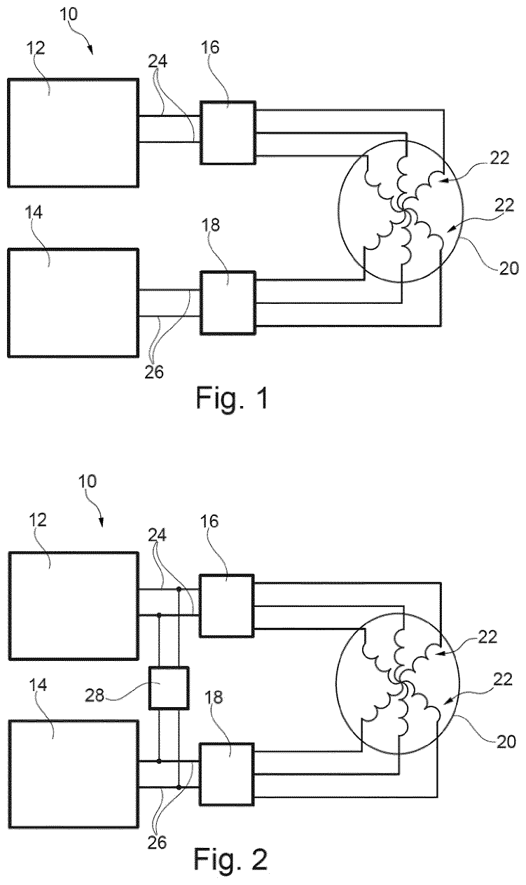

FIG. 1 shows a schematic representation of a drive train 10. The drive train 10 is, for example, a drive train for an electrically operated vehicle, such as an all-electric vehicle (BEV or FCEV), a hybrid or plug-in hybrid vehicle.

The drive train 10 comprises a first energy store 12, a second energy store 14, a first inverter 16, a second inverter 18 and an electric motor 20.

The two energy stores 12 and 14 are, for example, batteries, accumulators or capacitors. The energy stores 12, 14 can be constituted of smaller units, such as smaller batteries or accumulator cells.

However, it is also conceivable that more than two energy stores are provided in the drive train 10.

The first inverter 16 of the drive train 10 is assigned to the first energy store 12, and the second inverter 18 is assigned to the second energy store 14.

In the form of embodiment represented in FIG. 1 and FIG. 2, the first inverter 16 and the second inverter 18 are three-phase inverters, such that the inverters 16, 18 can convert direct current into an alternating current, in this case a three-phase alternating current.

The inverters 16, 18 are arranged between the energy stores 12, 14 and the electric motor 20, such that an electrical connection between one of the energy stores 12, 14 and the electric motor 24 is established by means of the respective inverter 16, 18.

The electric motor 20 has a plurality of phases 22. In the forms of embodiment represented in FIG. 1 and FIG. 2, six phases are provided.

In each case, three of the phases 22 are connected to one of the inverters 16, 18 by means of electrical lines, such that the first inverter 16 and the second inverter 18 are exclusively connected to the electric motor 20 on different phases 22.

This means that, by implication, each of the phases 22 is electrically connected either to the first inverter 16 or to the second inverter 18.

The first inverter 16 is electrically connected to the first energy store 12 by two electrical connecting lines 24, and the second inverter is electrically connected to the second energy store 14 by two further connecting lines 26.

Accordingly, a direct electrical connection is constituted between the first energy store 12 and the electric motor 20 by means of the first inverter 16, without the provision of further components between the electric motor 20 and the first inverter 16. The same applies to the second energy store 14 with respect to the second inverter 18, which connects the second energy store 14 directly to the electric motor 20.

For the operation of the drive train, i.e. for the propulsion of the vehicle or for braking, a control unit (not represented) of the drive train 10 or of the vehicle controls the drive train 10.

To this end, the following different modes of operation of the drive train 10 are available.

For moderate acceleration, energy is delivered to the electric motor 20 from the first energy store 12 or from the second energy store 14, by means of the first inverter 16 or the second inverter 18. Accordingly, the electric motor 20 assumes a maximum power, which corresponds to the maximum capacity of the first energy store 12 or of the second energy store 14.

If more power is required by the electric motor 20, or is demanded by the driver of the vehicle, additionally to the energy from the first energy store 12 (or the second energy store 14), energy is simultaneously delivered to the electric motor 20 from the second energy store 14 (or from the first energy store 12) by means of the second inverter 18 (or the first inverter 16), such that the maximum power of the electric motor now corresponds to the combined capacity of the two energy stores 12 and 14. Rapid acceleration is possible accordingly.

For braking maneuvers of the vehicle, similar modes of operation of the drive train are available. If a substantial deceleration is required, the first inverter 16, together with the first energy store 12, and simultaneously the second inverter 18 with the second energy store 14, can be regeneratively operated, such that the electric motor 20 generates electrical energy, which is simultaneously fed back to both the energy stores 12 and 14.

However, if a lesser deceleration is adequate, it is sufficient if only one of the inverters 16, 18, together with the associated energy store 12, 14 is operated regeneratively, such that electrical energy from the electric motor 20 is fed back to one of the energy stores 12 or 14.

The preference as to whether energy is to be fed back from the electric motor 20 to the first energy store 12 or to the second energy store 14 is determined by the control unit. For example, energy can consistently be fed back to the energy store 12, 14 in which less energy is momentarily stored.

In a further mode of operation of the drive train 10, energy can be transferred from one energy store 12, 14 to the other energy store 14, 12.

If, for example, energy is to be transferred from the first energy store 12 to the second energy store 14, in a braking maneuver, the second inverter 18, together with the second energy store 14, can be regeneratively operated for this purpose. At the same time, although a braking maneuver is currently in the course of execution, the first inverter 16, together with the first energy store 12, will operate in drive mode, such that energy is delivered from the first energy store 12 to the electric motor 20.

However, this energy delivered from the first energy store 12 to the electric motor 20 (in addition to the energy recovered during deceleration) is immediately fed back from the electric motor 20 to the second energy store 14 such that, effectively, a transfer of energy from the first energy store 12 to the second energy store 14 has been achieved.

In an equivalent manner, a transfer of energy can proceed between the second energy store 14 and the first energy store 12.

This type of energy transfer between the two energy stores 12, 14 is not restricted to a braking maneuver, but can also be executed during an acceleration maneuver, or during travel at a constant speed.

Thus, by means of the drive train 10, all the functions required for the operation of the drive train 10 can be executed, specifically a transfer of energy between the two energy stores 12, 14.

FIG. 2 shows a second form of embodiment of the drive train 10, which essentially corresponds to the first form of embodiment. Consequently, hereinafter, only the differences will be described, and identical or functionally equivalent components are identified by the same reference numbers.

Conversely to the drive train according to the first form of embodiment, the drive train 10 according to the second form of embodiment comprises a DC voltage converter 28. The DC voltage converter 28 is thus connected, on one side by means of the connecting lines 24 to the first energy store 12, and on the other side by means of the connecting lines 26 to the second energy store 14.

The DC voltage converter, additionally to the electrical connection via the electric motor 20, thus constitutes an additional connection between the first energy store 12 and the second energy store 14.

Via the DC voltage converter 28, energy can also be transferred from the first energy store 12 to the second energy store 14, or vice versa.

However, the DC voltage converter 28 is not employed for the transfer of the maximum energy from one of the energy stores 12, 14 to the electric motor 20, such that the selected maximum power rating of the DC voltage converter 28 can be significantly lower than the maximum capacity of one of the energy stores 12, 14. Moreover, the transfer of energy between the two energy stores 12, 14, in comparison with the energy transfer to the electric motor 20, also proceeds slowly, such that a low power rating of the DC voltage converter 28 can be selected, without influencing the function of the drive train 10.

In this manner, an efficient exchange of energy between the energy stores 12, 14 is possible, without the necessity for a large, heavy and/or expensive DC voltage converter 28.

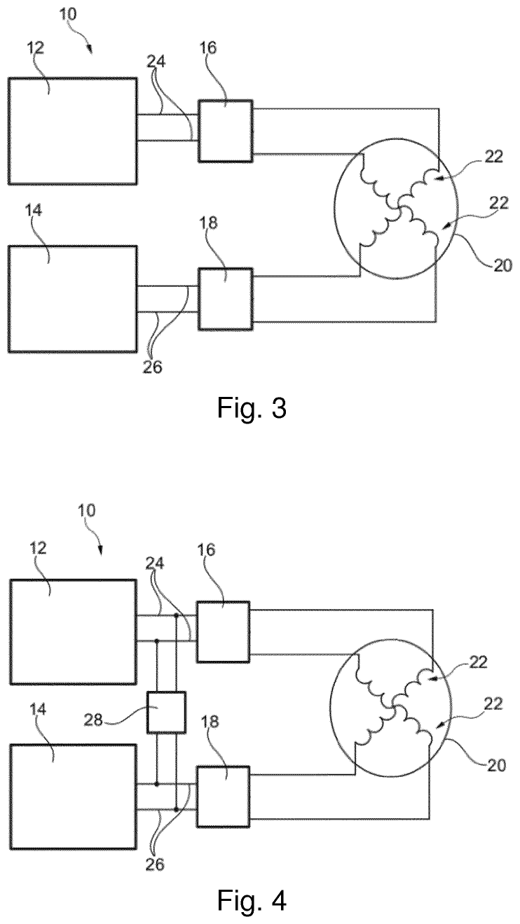

FIG. 3 shows a schematic representation of a further form of embodiment of the drive train 10. The drive train 10 is, for example, a drive train for an electrically operated vehicle, such as an all-electric vehicle (BEV or FCEV), a hybrid or plug-in hybrid vehicle.

The drive train 10 comprises a first energy store 12, a second energy store 14, a first inverter 16, a second inverter 18 and an electric motor 20.

The two energy stores 12 and 14 are, for example, batteries, accumulators or capacitors. The energy stores 12, 14 can be constituted of smaller units, such as smaller batteries or accumulator cells.

The first inverter 16 of the drive train 10 is assigned to the first energy store 12, and the second inverter 18 is assigned to the second energy store.

In the form of embodiment represented in FIG. 3, the first inverter 16 and the second inverter 18 are two-phase inverters, such that the inverters 16, 18 can convert direct current into an alternating current, in this case a two-phase alternating current.

The inverters 16, 18 are arranged between the energy stores 12, 14 and the electric motor 20, such that an electrical connection between one of the energy stores 12, 14 and the electric motor 20 is established by means of the respective inverter 16, 18.

In the form of embodiment represented in FIG. 3, the electric motor 20 has four phases 22.

In each case, two of the phases 22 are connected to one of the inverters 16, 18 by means of electrical lines, such that the first inverter 16 and the second inverter 18 are exclusively connected to the electric motor 20 on different phases 22.

This means that, by implication, each of the phases 22 is electrically connected either to the first inverter 16 or to the second inverter 18.

The first inverter 16 is electrically connected to the first energy store 12 by two electrical connecting lines 24, and the second inverter is electrically connected to the second energy store 14 by two further connecting lines 26.

Accordingly, a direct electrical connection is constituted between the first energy store 12 and the electric motor 20 by means of the first inverter 16, without the provision of further components between the electric motor 20 and the first inverter 16. The same applies to the second energy store 14 with respect to the second inverter 18, which connects the second energy store 14 directly to the electric motor 20.

For the operation of the drive train, i.e. for the propulsion of the vehicle or for braking, a control unit (not represented) of the drive train 10 or of the vehicle controls the drive train 10.

To this end, the following different modes of operation of the drive train 10 are available.

For moderate acceleration, energy is delivered to the electric motor 20 from the first energy store 12 or from the second energy store 14, by means of the first inverter 16 or the second inverter 18. Accordingly, the electric motor 20 assumes a maximum power, which corresponds to the maximum capacity of the first energy store 12 or of the second energy store 14.

If more power is required by the electric motor 20, or is demanded by the driver of the vehicle, additionally to the energy from the first energy store 12 (or the second energy store 14), energy is simultaneously delivered to the electric motor 20 from the second energy store 14 (or from the first energy store 12) by means of the second inverter 18 (or the first inverter 16), such that the maximum power of the electric motor now corresponds to the combined capacity of the two energy stores 12 and 14. Rapid acceleration is possible accordingly.

For braking maneuvers of the vehicle, similar modes of operation of the drive train are available. If a substantial deceleration is required, the first inverter 16, together with the first energy store 12, and simultaneously the second inverter 18 with the second energy store 14, can be regeneratively operated, such that the electric motor 20 generates electrical energy, which is simultaneously fed back to both the energy stores 12 and 14.

However, if a lesser deceleration is adequate, it is sufficient if only one of the inverters 16, 18, together with the associated energy store 12, 14 is operated regeneratively, such that electrical energy from the electric motor 20 is fed back to one of the energy stores 12 or 14.

The preference as to whether energy is to be fed back from the electric motor 20 to the first energy store 12 or to the second energy store 14 is determined by the control unit. For example, energy can consistently be fed back to the energy store 12, 14 in which less energy is momentarily stored.

In a further mode of operation of the drive train 10, energy can be transferred from one energy store 12, 14 to the other energy store 14, 12.

If, for example, energy is to be transferred from the first energy store 12 to the second energy store 14, in a braking maneuver, the second inverter 18, together with the second energy store 14, can be regeneratively operated for this purpose. At the same time, although a braking maneuver is currently in the course of execution, the first inverter 16, together with the first energy store 12, will operate in drive mode, such that energy is delivered from the first energy store 12 to the electric motor 20.

However, this energy delivered from the first energy store 12 to the electric motor 20 (in addition to the energy recovered during deceleration) is immediately fed back from the electric motor 20 to the second energy store 14 such that, effectively, a transfer of energy from the first energy store 12 to the second energy store 14 has been achieved.

In an equivalent manner, a transfer of energy can proceed between the second energy store 14 and the first energy store 12.

This type of energy transfer between the two energy stores 12, 14 is not restricted to a braking maneuver, but can also be executed during an acceleration maneuver, or during travel at a constant speed.

Thus, by means of the drive train 10, all the functions required for the operation of the drive train 10 can be executed, specifically a transfer of energy between the two energy stores 12, 14.

Advantageously, the four-phase electrical machine and the two-phase inverter can be configured such that costs of the components of the drive train can be reduced. Moreover, the connecting lines between the inverters 16, 18 and the electrical machine 20 are also additionally simplified accordingly.

FIG. 4 shows a further form of embodiment of the drive train 10, which essentially corresponds to the form of embodiment represented in FIG. 3. Consequently, hereinafter, only the differences will be described, and identical or functionally equivalent components are identified by the same reference numbers.

Conversely to the drive train according to the first form of embodiment, the drive train 10 according to the second form of embodiment comprises a DC voltage converter 28. The DC voltage converter 28 is thus connected, on one side by means of the connecting lines 24 to the first energy store 12, and on the other side by means of the connecting lines 26 to the second energy store 14.

The DC voltage converter, additionally to the electrical connection via the electric motor 20, thus constitutes an additional connection between the first energy store 12 and the second energy store 14.

Via the DC voltage converter 28, energy can also be transferred from the first energy store 12 to the second energy store 14, or vice versa.

However, the DC voltage converter 28 is not employed for the transfer of the maximum energy from one of the energy stores 12, 14 to the electric motor 20, such that the selected maximum power rating of the DC voltage converter 28 can be significantly lower than the maximum capacity of one of the energy stores 12, 14. Moreover, the transfer of energy between the two energy stores 12, 14, in comparison with the energy transfer to the electric motor 20, also proceeds slowly, such that a low power rating of the DC voltage converter 28 can be selected, without influencing the function of the drive train 10.

In this manner, an efficient exchange of energy between the energy stores 12, 14 is possible, without the necessity for a large, heavy and/or expensive DC voltage converter 28.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A drive train configured to electrically operate a vehicle, comprising:
an electric motor;
a first energy store and a second energy store, each of which is electrically connected to the electric motor; and
a first inverter and a second inverter,
wherein the first inverter is provided between the first energy store and the electric motor,
wherein the second inverter is provided between the second energy store and the electric motor, and
wherein the electric motor has four phases.

2. The drive train according to claim 1, wherein at least one of the four phases is only connected to the first inverter, and another of the four phases is only connected to the second inverter.

3. The drive train according to claim 2, wherein the first inverter and the second inverter are exclusively connected on the four phases of the electric motor.

4. The drive train according to claim 3, wherein the first inverter and the second inverter are two-phase inverters.

5. The drive train according to claim 1, wherein the first energy store and the second energy store are electrically interconnected by a DC voltage converter.

6. The drive train according to claim 2, wherein the first energy store and the second energy store are electrically interconnected by a DC voltage converter.

7. The drive train according to claim 3, wherein the first energy store and the second energy store are electrically interconnected by a DC voltage converter.

8. The drive train according to claim 4, wherein the first energy store and the second energy store are electrically interconnected by a DC voltage converter.

9. The drive train according to claim 1, wherein the energy stores are batteries, accumulators, capacitors and/or fuel cells.

10. A vehicle comprising a drive train configured to electrically operate the vehicle, wherein the drive train comprises:
an electric motor;
a first energy store and a second energy store, each of which are electrically connected to the electric motor; and
a first inverter and a second inverter,
wherein the first inverter is provided between the first energy store and the electric motor,
wherein the second inverter is provided between the second energy store and the electric motor, and
wherein the electric motor has four phases.

11. The vehicle according to claim 10, wherein at least one of the four phases is only connected to the first inverter, and another of the four phases is only connected to the second inverter.

12. The vehicle according to claim 11, wherein the first inverter and the second inverter are exclusively connected on the four phases of the electric motor.

13. The vehicle according to claim 12, wherein the first inverter and the second inverter are two-phase inverters.

14. The vehicle according to claim 10, wherein the first energy store and the second energy store are electrically interconnected by a DC voltage converter.
